(19) United States
(12) Patent Application Publication
(10) Pub. No.: US 2014/0193788 A1
(43) Pub. Date: Jul. 10, 2014

(54) METHOD, A DEVICE AND A COMPUTER PROGRAM PRODUCT FOR TRAINING THE USE OF AN AUTO-INJECTOR

(71) Applicants: Bryce Vernon Groves, London (GB); Henry Samuel Yeates, Berkshire (GB); Gareth Michael Coady, Vale Of Glamorgan (GB); Stephen Lombardelli, Slough (GB)

(72) Inventors: Bryce Vernon Groves, London (GB); Henry Samuel Yeates, Berkshire (GB); Gareth Michael Coady, Vale Of Glamorgan (GB); Stephen Lombardelli, Slough (GB)

(73) Assignee: ALK AG, Volketswil (CH)

(21) Appl. No.: 14/129,499

(22) PCT Filed: Jun. 28, 2012
(86) PCT No.: PCT/EP2012/062610

§ 371 Date: Dec. 26, 2013

Related U.S. Application Data
(60) Provisional application No. 61/502,087, filed on Jun. 28, 2011.
(60) Provisional application No. 61/585,036, filed on Jan. 10, 2012.

(30) Foreign Application Priority Data
Jan. 10, 2011 (EP) 12150549.9
Jun. 28, 2011 (EP) 11171725.2

(51) Int. Cl. G09B 23/28

(52) U.S. Cl. CPC G09B 23/28
USPC 434/262

(57) ABSTRACT

The invention provides a handheld device for training a user in operating an auto-injector. The device has a screen and a sensor which can quantify a physical activity of the device. A visual representation of the auto-injector and a visual instruction for a desired use of the auto-injector are presented on the screen while the user is requested to manipulate the handheld device as if it was the auto-injector. By use of the sensor date, the device evaluates the performance of the user and determines a level of compliance with the instructions. Accordingly, the invention provides an increased safety in the use of auto-injectors e.g. for epinephrine (adrenaline).

### INTRODUCTION

The present invention relates to a method and a device for training a user in operating an auto-injector, e.g. an epinephrine auto-injector. The invention further relates to a computer program especially for a mobile phone or similar hand held device, and a medium comprising the computer program.

### BACKGROUND

An auto-injector is a medical device used to deliver a measured dose of a drug, e.g. epinephrine also known as adrenaline. Epinephrine is most frequently used for the treatment of acute allergic reactions to avoid or treat the onset of an anaphylactic shock.

Typically, an auto-injector contains a spring-loaded needle that exits the tip of the device and penetrates into the recipient's body to deliver the medication. The device contains a predetermined dose of the drug in question.

Typically, the device is held with its tip tightly against the leg and the device is activated by a push against the leg, or activated in a ballpoint pen-fashion. After activation, the user holds the device in place for e.g. 10 seconds as the epinephrine is delivered. This gives the drug sufficient time to be absorbed by the body's muscles and diffused into the bloodstream. In most countries, epinephrine is a prescription drug, and therefore obtaining the device also requires a prescription from a doctor. Consequently, training in the correct use of the device is important.

The epinephrine auto-injector can be seen as insurance against a very rare incident—hopefully the patient will never have to use the auto-injector at all, and the auto-injector will be carried along just for the very rare occasion where treatment of an anaphylactic shock is required. Accordingly, the user is most likely never becoming an experienced user of the epinephrine auto-injector.

Typically, makers of epinephrine auto-injectors provide simulation auto-injectors which function exactly as real auto-injectors, however without including epinephrine, and with needles which are resetable for repeated use. This enables frequent use of the simulation auto-injector and thereby enables the user to become experienced even though the real auto-injector is never, or only rarely, being used.

Since correct use involves parameters which are difficult to estimate, e.g. correct orientation of the auto-injector and correct timing, it is often difficult for the user to judge when sufficient skills for safe use are achieved and the simulation auto-injector does not provide guidance beyond what is provided in a written instruction for use.

The existing simulation auto-injectors take up space and they are unpleasant to carry along. Accordingly, it is typically only the patient who trains with the simulation device, and typically only when being at home. This is not always desirable since some patients experience sudden and unexpected attacks and therefore rely on help from others with regard to the use of the auto-injector.

### DESCRIPTION OF THE INVENTION

It is an object of embodiments of the invention to provide improved training for the correct use of auto-injectors.

It is a further object of embodiments of the invention to provide a training device which can be carried along and which easily and with no costs can be distributed to a large amount of people, e.g. acquaintances of the patient.

It is a further object of embodiments of the invention to increase the educational level of the public, not only patients, and in particular to increase the knowledge regarding auto-injectors and the correct use thereof—particularly with regard to epinephrine auto-injectors and similar auto-injectors because a patient may rely on help from others to administer the injection.

Accordingly, the invention, in a first aspect, provides a method for training the use of an epinephrine auto-injector, the method comprising providing a handheld computer device with a screen, a motion sensor adapted to provide motion sensor data, and an electronic circuit adapted to recognise a gesture based on the motion sensor data; providing instructions on the screen, the instructions being for a desired use of the auto-injector; representing the auto-injector visually on the screen; providing via the handheld device a request for the user to manipulate the handheld device as if it was the auto-injector; wherein the user manipulates the handheld device while the sensor provides the motion sensor data, the manipulation comprising pressing the device against a thigh, and wherein the electronic circuit is used for recognising a gesture to determine a level of compliance with the instructions.

In a second aspect, the invention provides a handheld computer device for training a user in operating an epinephrine auto-injector, the device comprising a screen; a motion sensor adapted to provide motion sensor data; and an electronic circuit adapted to recognise a gesture based on the motion sensor data; the device further being adapted to provide instructions on the screen for a desired use of the auto-injector, the instructions comprising a request for the user to manipulate the device itself as if it was the auto-injector including a request to press the device against a thigh, where the electronic circuit is adapted to recognise a gesture in order to determine a level of compliance with the instructions.

In a third aspect, the invention provides a computer program product readable by a hand held computer device comprising a screen; a motion sensor adapted to provide motion sensor data; and an electronic circuit, the computer program product comprising a set of instructions for the device, the instructions enabling the device to:
represent the auto-injector visually on the screen;
to provide instructions on the screen for a desired use of the auto-injector, the instructions comprising a request for the user to manipulate the device itself as if it was the auto-injector; and
evaluate the motion sensor data to recognise a gesture in order to determine a level of compliance with the instructions.

The computer program product may e.g. enable recognition if manipulation of the handheld device corresponds to a pre-defined gesture stored in memory of the device in order to determine the level of compliance with the instructions. The computer program product may further include any of the features mentioned relative to the first and second aspects of the invention. Particularly, the computer program product may enable the device to provide a timer function to count a duration after the recognition of the user having pressed the device against the thigh, and to enable the device to identify an orientation of the device while the timer counts. The computer program product may further enable the device to identify the entire movement path constituting the training session and to compare that path with a desired reference path stored in the device, e.g. as part of the computer program product.

In a fourth aspect, the invention provides a computer-readable medium comprising the computer program according to the third aspect of the invention. This enables easy distribution of the program to a wide group of people, e.g. via upload from well-known providers of applications for handheld computer devices such as mobile phones or game controllers. The computer-readable medium may include a USB dongle with an EPROM chip with the software such that the invention can be adapted in any electronic device capable of reading such a dongle.

Since the device is capable of evaluating the motion sensor data and thereby to identify an activity of the user and determine a level of compliance, the device may effectively be used for training use of an auto-injector.

Since the training device is implemented as a handheld computer device with a screen and a motion sensor, the training device can be implemented on a very large amount of existing electronic devices already being used by a variety of people, examples include mobile phones, electronic game controllers, path finders or GPS trackers etc. Accordingly, the invention enables training of people in different situations, patients or non-patients, and irrespective of their individual background.

In particular, the mentioned handheld computer devices are easy to bring along and they often have a size suitable for simulating the activity of an auto-injector. Particularly mobile phones are nearly always ready at hand which is an advantage. Use of a mobile phone with a computer program according to the present invention facilitates frequent training sessions. Additionally, the communication capabilities of a mobile phone may enable sharing of the training session and the achieved results between groups of people. It may be used in social events, whenever sitting in a group, one person may use the mobile phone to educate the others in the correct use of an auto-injector, and everyone may, in an easy and amusing way, get acquainted with a risk e.g. of anaphylactic shock and the corresponding treatment.

By “handheld” it is herein defined that the device is self-powered, i.e. powered by battery or solar cells or the device may, in any similar manner, be independent on power from a fixed grid. It is also defined that the device is of a size, weight, and shape which enables manipulation by hand as a substitute for a real auto-injector.

Typically, an auto-injector has a weight between 20 and 200 gram and it is desirable that the device has a weight within a similar range, or within a range of 100-400 gram, such as 150-300 gram, such as 180-250 gram such as 200-220 gram, which is also acceptable for providing the feeling of manipulating the real auto-injector.

The device may have the form of an elongate, flat box with two substantially parallel main faces, two substantially parallel side portions, and substantially parallel bottom and top end portions. During use, the user may grab the device by pressing the hand at least against the side portions. When holding the device in this way, the user may move the device until the bottom end portion is pressed against the thigh. The thumb of the user may e.g. engage the top end portion, or the user may place the thumb against one of the side portions and at least one of his remaining four fingers against the other one of the side portions, so as to firmly hold the handheld device between the thumb and the remaining four fingers.

Herein, the terms “handheld computer device”, “computer device” or simply “device” all cover a handheld computer with a screen, an electronic circuit which, e.g. by programming, is capable of providing the claimed gesture recognition and determination of a level of compliance with the instructions. It could be constituted by a device specifically made for training purpose, or it may form part of a standard device which is originally made for general computer purpose, or it may be constituted by, or form part of a mobile phone, a game controller, or a sport computer e.g. for navigation, biking or running.

Particularly, such standard electronic devices may include a sensor which can determine motion. Herein, “motion sensor” generally refer to any kind of sensor, e.g. in combination with suitable data processing, capable of detecting movement of the device. Examples of such sensors include accelerometers, gyros which can determine orientation, or other sensors which could advantageously constitute the motion sensor according to the invention. The sensor could e.g. comprise an acceleration sensor, e.g. a 3 axis acceleration sensor capable of providing acceleration in three distinct directions, e.g. in x-y-z direction with 90 degrees between each direction.

Additionally, the device includes a screen, typically a touch-screen, and an electronic circuit capable of handling data from the touch-screen sensor. Additionally, the device may include a timer.

The device can identify a specific physical activity carried out on the device, e.g. to provide a signal when movement of the device in a specific direction is stopped, i.e. to provide gesture recognition.

In connection with the present invention “gesture recognition” is the activity of the hand held computer device to analyse the motion sensor data and recognise a specific gesture, i.e. a specific movement of the device. Once a gesture is recognised, the electronic circuit may determine a level of compliance with the instructions by comparing the recognised gesture with a desired gesture. The electronic circuit may e.g. recognise if manipulation of the handheld device corresponds to a pre-defined gesture stored in memory of the device in order to determine the level of compliance with the instructions.

Gesture recognition may be used for determining when the user has pressed the device against the thigh, which gesture with the real auto-injector would typically release the needle and cause injection of the epinephrine or similar drug. Gesture recognition may further be used for determining if the device is held in a correct angle.

To obtain the claimed identification of gestures, including the movement of the device against the thigh, the data from the sensor is evaluated by the electronic circuit. The electronic circuit could be specifically build for this purpose. If, however, the device is a standard electronic device such as a mobile phone, the electronic circuit may be constituted by the processor in such a device and the computer program product according to this invention.

In connection with the present invention it is specified that the user “manipulates” the handheld computer device. Herein, this means that the user moves the device, e.g. as instructed by the instructions on the screen. Typically, the movement involves several well defined gestures including the gesture of holding the device in a certain orientation, e.g. upright, the gesture of moving the device to the thigh, the gesture of holding the device against the thigh, and the gesture of moving the device away from the thigh while maintaining the orientation of the device.

Once a gesture is recognised and the device has determined a level of compliance with the instructions, the user may be informed about the level of compliance, e.g. by visual indication on the screen or audibly by a sound, e.g. one sound or picture indicating “no-compliance” and another sound or picture indicating “compliance”.

Particularly, the gesture of pressing the device against the thigh may be recognised by the electronic circuit. This gesture may be recognised e.g. based on speed or acceleration of the device. Once the device arrives at the thigh, the speed goes to zero and the sudden negative acceleration may constitute the recognition of the gesture. The electronic circuit may therefore be adapted to compare an acceleration profile or a speed with a reference acceleration profile or speed.

The handheld device comprises a timer which is activated upon recognition of a gesture indicating that the handheld device has been pressed against the thigh. This may be used for training the perception of the time which is necessary for the drug substance to be injected. When the device is pressed against the thigh, the user may maintain the pressure for a period of time, which period of time is counted by the timer. In this period, the user may hold the device in a pre-defined orientation, and that gesture may also be recognised by the electronic circuit. Once again, the recognised gesture may be compared with a desired gesture, and the user may be informed about compliance or non-compliance.

The electronic circuit may be activated to establish the recognition of the gesture of orientating the handheld device in the pre-defined direction either prior to the pressing of the device against the thigh and/or after recognition of the gesture indicating that handheld device has been pressed against the thigh.

The electronic circuit may further be activated to establish the recognition of the gesture of orientating the handheld device in the pre-defined direction prior to the activation of the above mentioned timer, and the electronic circuit may be adapted continuously to recognise the gesture while the timer is activated.

Particularly, the step of determining the level of compliance may be carried out by comparing the motion sensor data with target reference data which expresses a desired manipulation of the device, and which have been preloaded into the device, and the level of compliance may comprise the step of informing the user of whether the motion sensor data is in accordance with the target reference data or not. Initially, a desired movement path of the auto-injector for achieving a transcutaneous injection with the auto-injector can be determined, e.g. by recording such a movement by use of a GPS based tracker or by use of similar recording means for recording positions. The desired movement path may include the desired movement of the auto-injector until it is stopped against a thigh of the user, and the continued maintenance of a fixed orientation for a suitable period of time.

Subsequently, the data expressing said desired movement path may be preloading data into a memory of the handheld device. In one example, the data forms part of the above mentioned program code for a standard electronic device.

Finally, the device may be adapted to sample data from the sensor and to process the data while the user moves the handheld device along a possibly correct movement path. The device may be adapted to determining a deviation between the sampled data and the preloaded data, and to provide an output representing said deviations to the user and thereby to inform the user about the compliance with the instructions.

In addition to the identification of the device being pressed against the thigh of the user, device may provide gesture recognition for identifying other gestures of the training sequence. As an example, the device may identify:
the orientation in which user initially holds the device before moving the device to the thigh,
the orientation and/or speed by which the user moves the device towards the thigh,
the orientation while the device is pressed against the thigh, and
the orientation of the device and/or speed by which the device is moved away from the thigh after ended simulated injection.

Each of these above-mentioned gestures may, once they are recognised, be compared with a desired gesture. As an example, the device may provide a signal when the device is in an upright orientation. This could indicate when the user holds the device in a correct orientation ready to be pushed firmly against the thigh.

In use, the device is activated, and the instructions on the screen are followed. In one example, the following procedure is provided:
An auto-injector is illustrated on the screen. By text on the screen or by audible, spoken instruction, the user is instructed to unwrap the auto-injector or in similar way to make the auto-injector ready for use, e.g. by removing a shielding cap or similar protection;
The user manipulates the illustrated auto-injector by moving fingers over the screen, e.g. such that the cap is removed by the fingers;
By text on the screen or by audible, spoken instruction, the user is instructed to raise the device to an angle which is suitable for the sub cutaneous injection. While the user moves the device to a possibly correct orientation, the data from the sensor constantly identifies an actually obtained orientation and compares that orientation with the desired orientation;
When the actually obtained orientation is sufficiently close to the desired orientation, i.e. when the difference is within a pre-defined limit, the user is notified that the angle is correct and the injection may take place;
By text on the screen or by audible, spoken, instruction the user is instructed to move the device until it is arrested against the thigh.
The electronic circuit is programmed to evaluate data from the sensor to identify the activity when the device actually arrives at the thigh. For this purpose, the speed and/or the acceleration of the device is determined and compared with a reference value. In one example, the activity is identified when a negative acceleration above a limit value is determined or when a speed below a limit value is determined;
Once the activity of the device having arrived at the thigh is identified, a timer which is integrated in the device is started and counts a desired period of time, typically 1-20 seconds, such as 2-12 seconds, such as 3-10 seconds, such as 4-8 seconds, in which the device should be held relatively still. This is the period of time which is desired for the drug substance to be injected; The user may be notified about the progress, e.g. by visual indication of the progress on the screen or by audible indication of the progress;
While the timer counts the desired period of time, the electronic circuit continuously identifies the orientation of the device and informs the user if the angle relative to gravity or relative to the thigh is outside a predetermined desirable interval;
When the timer has counted the desired period of time, the user is notified that the training session is ended with or without success. With success typically means that the user has been able to follow a specifically, predetermined and pre-programmed path and sequence of movement for the device including initially orienting the device correctly, moving the device towards the thigh, e.g. with a specific minimum speed, and finally been able to maintain a correct angle of the device during the required amount of time.

The motion sensor could be built into the device or it could be an external sensor Furthermore, certain existing devices such as the Iphone™, the Ipod Touch™ and other devices may have a connector in which an additional sensor may be attached, e.g. a pressure sensor. Such devices may be used in connection with the invention to further enhance the application according to this invention by providing compliance monitoring for finding the correct orientation and further for finding that physical activity or point in time when the device is pressed against the thigh.

The screen could be a regular screen of the kind well known from small electronic devices including mobile phones. The interaction could be established by the use of push buttons or similar sensors, or motion detectors etc. In one embodiment, however, an important part of the user interaction is established via a touch screen, preferably of a size allowing display of the auto injector in an at least close to 1:1 size or at least between 1:1 and 1:4 of the real size. I.e. if the auto-injector has a length of e.g. 16 cm, it is desirable if the screen has a length between 4 and 16 cm, e.g. between 6 and 8 cm long. The width may e.g. be between 4 and 7 cm.

By “physical activity” is herein defined an activity which is carried out by the user on the device, e.g. an activity of touching the screen or an activity of shaking or moving the device. By this definition, the motion sensor can quantify a physical activity. The motion sensor may comprise any number of sensor or processors.

The visual representation of the auto-injector may be actively adaptable to a specific step in the use of the auto-injector. As an example, the user may be requested to unwrap the auto-injector, and the screen may visualize the auto-injector in a state where it is wrapped-in until an activity is carried out, and in an un-wrapped state as soon as the activity is acknowledged. Likewise, the auto-injector may have a cap which can be pulled off, and the screen may visualize the auto-injector in a state with the cap and in a state without the cap. Typically, the auto-injector also has a state with the needle being retracted and a state with the needle projecting from the tip. Again, the visual representation may include both states.

The request for the user to manipulate the device itself as if it was the auto-injector may be provided in writing on the screen or orally by use of a speaker. The request may be followed by audio signals, e.g. one signal representing successful compliance with the instructions and one signal representing a failure to comply with the instructions.

Generally, the evaluation of motion sensor data may include checking if the orientation of the device is acceptable, checking if the time during which the device is pressed against the thigh is acceptable etc. It may also include checking if the training session is repeated with a certain frequency or checking if it is repeated in case of failure.

In a particular embodiment of the invention, the device comprises a timer for determining duration of a physical state, position or orientation of the device, the timer may e.g. form part of the sensor. In one embodiment, the sensor is adapted to determine an orientation of the device relative to horizontal. If it is desirable for the needle to penetrate the muscle with a specific angle relative to the muscle, the instructions may relate to an orientation of the auto-injector relative to an orientation of the user, e.g. by specifying that the user should hold the leg in a certain angle relative to horizontal or vertical, and by subsequent checking of the actual angle of the device relative to horizontal or vertical.

It may be particularly desirable to carry out the evaluation of data from the sensor while the instructions are provided on the screen. This may enable the user to learn more quickly how to adjust the behaviour to the desired behaviour e.g. with regard to finding a correct angle of the device etc. Accordingly, the device may be adapted to iteratively provide instructions and obtain motion sensor data for subsequent adjustment of the instructions based on the measurements etc. As an example, the device may repeatedly state that the device should be held further upright until the motion sensor registers an angle of the device being within an acceptable range.

The instructions may be selected from a library of predefined instructions. The predefined instructions may be stored in the library e.g. as individual program sequences which contain visual representation of a sequence of the complete instruction such that the program sequence handles visualization on the screen and/or response from the user, e.g. in the form of gesture recognition.

The predefined instructions may also be stored in the library as sound-data-files such as Way, AAc, MP3 etc. where each sound-data-file contains oral instructions corresponding to a sequence in the complete instruction.

As an example, the complete instruction session could be split into a number of sequences and each sequence may relate to a physical activity which must be carried out by the user. The device may then jump to a new instruction in the sequence of predefined instructions every time the user has complied with the instructions.

If the user has been unable to comply with the instructions of one sequence of instructions, new and more detailed instructions may be given, e.g. instructions more specifically directed to the error in question, c.f. the above example where the user is instructed to hold the device further upright. Accordingly, each sequence in the series of sequences may have several different predefined instructions depending on the degree of compliance the user can prove. The instructions may therefore be selected from the library depending on a recognised gesture, e.g. depending on a difference between a desired gesture and a recognised gesture.

The device may also be adapted to receive user feedback. Herein user feedback is defined as any question or command provided by the user to the device.

The user feedback could be provided via a keyboard, e.g. defined visually on a touch screen of the device.

The user feedback could also be provided orally, i.e. the user may ask the device questions or instruct the device orally.

As an example, the user may ask the device if the duration can be shorter, if the angle is right, if the cap has been removed from the needle etc. The user may also ask questions related more generally to the use of the device which is simulated, e.g. “is use of epinephrine considered dangerous”, or “how long time do I have from an anaphylactic shock takes place until the treatment must be carried out”.

The device may contain an expert system which looks up any available entry related to the question or command—e.g. by use of external databases, the Internet etc., or simply by use of a build-in-database. If the questions or commands are provided orally, the device may have a database with comparable standard commands or questions such that the oral command or question can be recognised.

In one embodiment, the device and the instructions are particularly adapted for a desired use of an epinephrine auto-injector. This specific use will be explained in further details with reference to the specific embodiment and the drawings.

In addition to the instructions and simulation of use of an auto-injector, the device may include other functions related to the use of the auto-injector. In case of an epinephrine auto-injector, the device may further be adapted to represent anaphylaxis graphically on the screen. This may e.g. include visual representation of blood pressure, heart rate, peak flow, skin colour or other physiological responses to anaphylaxis. The device may e.g. utilise sensors for finding an actual physical state of a patient, e.g. a heart rate, or the device may contain an information sequence with general information about the physiological responses which should be kept in mind. General information could be valuable not least for the patient to share with colleagues, friends and relatives so that the people typically being around the patient know what to look for.

As already mentioned, the epinephrine auto-injector is hopefully never going to be used and most patients will never become experienced in using the real auto-injector. Moreover, auto-injectors with epinephrine must be replaced frequently, typically every second year, due to degradation of the medical substance in the auto-injector. Accordingly, new models of the real auto-injector with new features etc. may be introduced. In order to improve the ability of the user to repeatedly update the training device and in order to improve the ability of the user to frequently use the training device, the device may form part of a mobile phone such as an Iphone™ or an Android™ phone. In this case, the mentioned electronic circuits and sensors form part of the integrated devices in such phones, and the functions are operated by the use of suitable software loaded into the memory of the mobile phone in question whereby the device becomes capable of identifying the claimed gestures and thereby becomes useful for training purpose.

To ensure correct match between the training which is carried out and the real auto-injector, the device may be adapted to read an identification insignia obtained from the real auto-injector, and to adapt the instructions and the auto-injector visualization to that auto-injector being identified by the insignia. The identification insignia could include a bar code or any similar code which can be read by the device automatically. The identification insignia may further include information regarding the lifetime of the real auto-injector such that the training device can alert the user when the real auto-injector must be replaced with a new one.

When the user replaces a real auto-injector with a new auto-injector, the identification insignia is entered into the device, and the device may now be adapted to automatically alert the user if the new real auto-injector works in a different manner or otherwise requires changes in the operation procedure.

The invention relates to the following particular embodiments:

A method where the user is informed about the level of compliance with the instructions.

A method where the gesture of pressing the device against the thigh is recognised by the electronic circuit.

A method where the gesture of pressing the device against the thigh is determined from the motion sensor data by evaluating if movement of the device in a specific direction is stopped.

A method where the handheld device comprises a timer which is activated upon recognition of a gesture indicating that handheld device has been pressed against the thigh.

A method where the pressing of the device against the thigh is maintained for a period of time, which period of time is counted by the timer.

A method where the user holds the device in a pre-defined orientation

A method where the gesture of holding the device in the pre-defined orientation is recognised by the electronic circuit.

A method where the electronic circuit is activated to establish the recognition of the gesture of orientating the handheld device in the pre-defined direction prior to the pressing of the device against the thigh.

A method where the electronic circuit is activated to establish the recognition of the gesture of orientating the handheld device in the pre-defined direction after recognition of the gesture indicating that handheld device has been pressed against the thigh.

A method where the electronic circuit is activated to establish the recognition of the gesture of orientating the handheld device in the pre-defined direction prior to the activation of the timer.

A method where the gesture recognition of holding the device in the pre-defined orientation is continued while the timer is activated.

A method where the step of determining the level of compliance is carried out by comparing the motion sensor data with target reference data which expresses a desired manipulation of the device, and which have been preloaded into the device.

A method where the step of determining the level of compliance further comprises the step of informing the user of whether the motion sensor data is in accordance with the target reference data or not.

A method where the handheld device substantially has the form of an elongate, flat box with two substantially parallel main faces, two substantially parallel side portions, and substantially parallel bottom and top end portions, and wherein the user grabs the device by pressing the hand at least against the side portions and subsequently moves the device until the bottom end portion is pressed against the thigh.

A device comprising memory means with preloaded data expressing at least one pre-defined gesture corresponding to the instructions, the device being adapted to sample, by means of said motion sensor, data expressing obtained movement of the device while the user moves the device, said sampled data comprising at least an angle of the device, the device being adapted to determine a deviation between the sampled data and the preloaded data and to provide an output representing said deviations to the user.

A device wherein the motion sensor comprises a three-axis acceleration sensor capable of providing acceleration in three distinct directions.

A device comprising a timer which is set to activate upon recognition of a gesture indicating that a user has pressed the device against a thigh.

A device adapted to identify a gesture of holding the device in the pre-defined orientation.

A device comprising a library of predefined instructions, the device being adapted to select the predefined instructions depending on an instruction sequence.

A device wherein the device is adapted to express the instructions audibly.

A device where the instructions are selected from the library depending on a recognised gesture.

A device wherein the instructions are for the desired use of an epinephrine auto-injector.

A device adapted to read an identification insignia obtainable on a real auto-injector, and to provide instructions and visual representation of that auto-injector being identified by the insignia.

A device wherein the identification insignia includes information regarding the lifetime of the real auto-injector, the device being adapted to alert the user when the real auto-injector must be replaced with a new one.

### BRIEF DESCRIPTION OF THE DRAWINGS

The invention will now be described by way of example with reference to following figures in which:

FIG. 1 illustrates a device according to the invention;

FIGS. 2-6 illustrate the device with different parts of the visual instruction for use on the screen; and

FIGS. 7-8 illustrate further screens of a device according to the invention

### DETAILED DESCRIPTION OF AN EMBODIMENT

Further scope of applicability of the present invention will become apparent from the following detailed description and specific examples. However, it should be understood that the detailed description and specific examples, while indicating preferred embodiments of the invention, are given by way of illustration only, since various changes and modifications within the scope of the invention will become apparent to those skilled in the art from this detailed description.

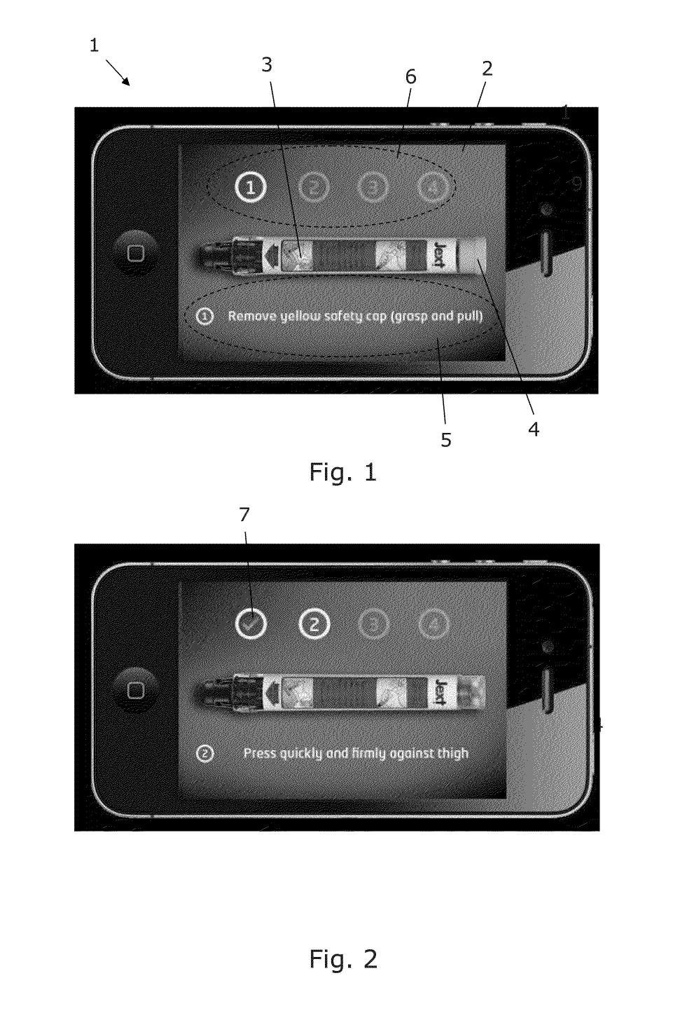

FIG. 1 illustrates a handheld device 1 for training a user in operating an auto-injector. The disclosed device is for training in the use of an epinephrine auto-injector device and it comprises a screen 2 and three sensors, one of which is a motion sensor which can quantify a physical activity of the device, namely acceleration.

A first sensor determines acceleration and may, with appropriate data processing, determine movement of the device. As an alternative or in addition to the acceleration sensor, the first sensor may include a gyro. A second sensor can determine touch on the screen (touch-screen-sensor), and the third sensor is a clock which can determine duration of an activity, or duration of a lack of activity related to the other sensors.

As indicated in any one of FIGS. 1-6, the screen provides a visual representation of the auto-injector 3. Additionally, the device provides instructions for the user on how to use and manipulate the auto-injector. These instructions include a request for the user to manipulate the device itself to simulate that the device is the auto-injector. These instructions may be provided visually on the screen or they may be provided audibly via a speaker.

For the purpose of providing oral instructions via the speaker, the device may have a database containing a set of sound-data-files, e.g. in a standard format such as way, MP3, AAC. The data files could be in different languages. The handheld device controls execution of the data files such that each oral instruction is provided at the right sequence of the instruction. As an example, one instruction file may instruct the user to press the handheld device against the thigh, and if the movement is not recognised by the device as a “correct” injection, i.e. if gesture recognition does not recognise a correct gesture, another data file may provide oral instructions related to the recognised gesture. If the angle was too steep, the oral instruction may be to lower the handheld device etc. Accordingly, the oral instructions may be selected from a library of oral instructions depending on the sequence in a series of sequences defining the instructions, or the oral instructions may be selected from a library of oral instructions depending on a recognised gesture or difference between a desired gesture and a recognised gesture.

An electronic circuit in the device evaluates data from the sensors and provides a level of compliance with the instructions.

In FIG. 1 which illustrates a first step of the instruction session, the user is requested to remove a safety cap 4 in the right side of the illustrated auto-injector 3. The instructions are provided in writing in an instruction field 5 on the screen 2 and the user is informed about which step in the instructions that is carried out in a step indicator 6.

The screen is touch sensible and the device registers when the user virtually pulls off the safety cap by touching the screen and sliding the fingers over the screen. The device acknowledges the procedure by use of an audible signal and by marking the first step done with a tag 7 in the step indicator, c.f. FIG. 2.

FIG. 2 illustrates a second step which is initialized by compliance with the first step. In the second step, the user is requested to press the device against the thigh as if the device was the auto-injector itself. The acceleration sensor, or any similar sensor capable of determining movement and/or orientation of the device, determines the angle of the device. In this particular application, the auto-injector is for epinephrine, and the angle of the needle during intrusion into the muscle should typically be between 0 and 90 degrees from vertical, preferably between 10 to 80 degrees from vertical, more preferably between 20 to 70 degrees from vertical, more preferably between 30 to 60 degrees from vertical, more preferably between 35 and 55 degrees from vertical, such as between 37 and 52 degrees from vertical, such as between 39 and 49 degrees from vertical, such as approximately 45 degrees from vertical. Additionally, the screen may provide additional guidance, e.g. relative to a desired angle relative to the thigh.

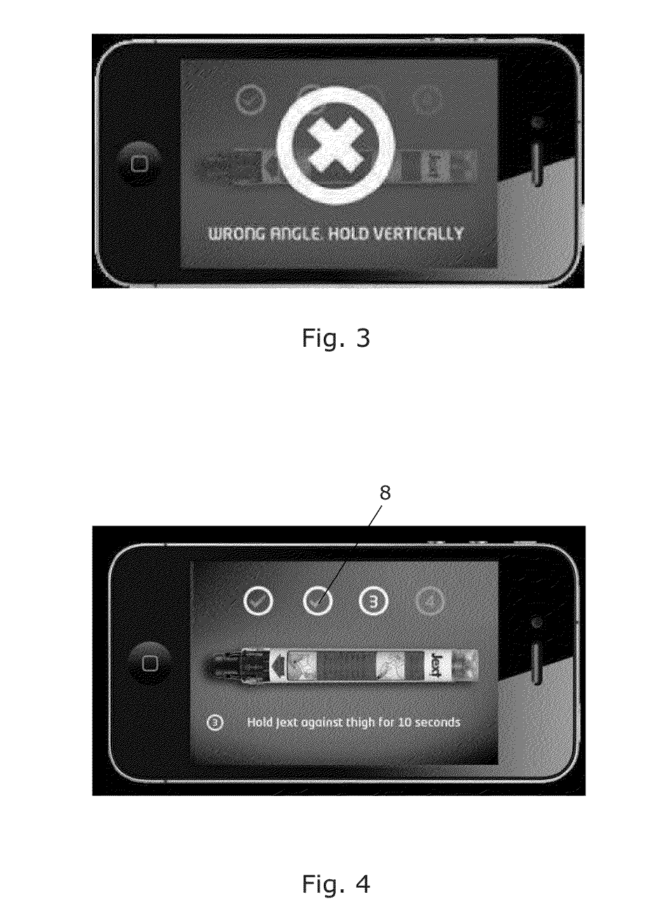

FIG. 3 illustrates a warning which is generated if the device is held in an angle outside the desired 0-90 degrees range from vertical. The warning includes also an acoustic signal.

FIG. 4 illustrates the device when it has been acknowledged that the angle is correct, the acknowledgement includes an acoustic signal and a tag 8 in the step indicator 6.

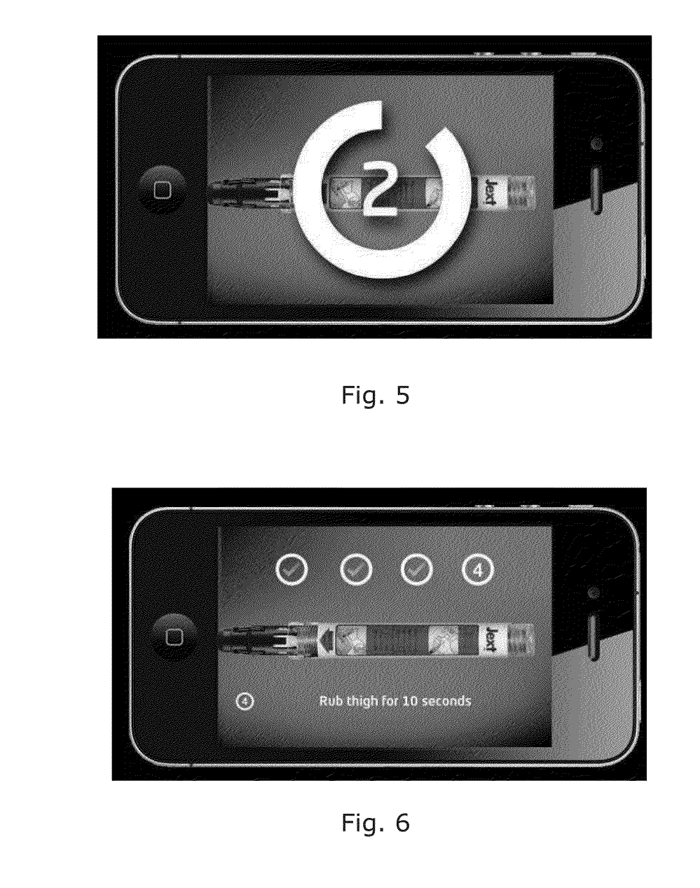

When the user pushes the device towards the thigh, the acceleration sensor can determine the deceleration and thereby register that the virtual needle is now inside the muscle. FIG. 5 illustrates the pen being pushed to the left side of the screen to indicate that the device has registered this step and now considers the needle being injected. The acknowledgment is also followed by the sound of a spring which is released. This simulates the sound of the spring in the real auto-injector which makes the needle spring forward into the muscle. The timer starts counting 10 seconds. In FIG. 5, two seconds have been counted, and when 10 seconds have been counted, the device acknowledges correct procedure by shifting to the screen shown in FIG. 6.

The device illustrated in FIGS. 1-6 is an Iphone™ phone device. Mobile phone devices are typically ready at hand, and advanced mobile phones have build-in sensors of the kind described above. Accordingly, the user is capable of training correct use of the auto-injector whenever it is appropriate without having to carry an additional separate training device.

In the following, the features of the device are described in further details. When the cap is removed by movement of fingers across the touch-screen, a timer counts 3 seconds and during this period of time, the device evaluates the angle of the device relative to vertical or relative to a downwards direction determined by use of gravity. In an Iphone™ and in similar devices, the angle is typically subject to a deviation of plus/minus 10 degrees.

If, after three seconds, the angle is incorrect, the user is notified and requested to improve.

If the angle is correct, the device will use gesture recognition to identify when the device is pressed against the thigh. In one particular example, the device comprises three acceleration sensors for determining acceleration in three distinct directions, typically in X-Y-Z directions of a Cartesian coordinate system, i.e. with 90 degrees angle between each direction. Ipones™, Ipads™ and similar devices typically include such acceleration sensors. In development of programs for such devices, the programmer is offered three vectors each describing the acceleration in the different directions, i.e. the direction and size of the acceleration where the size is provided in form of the vector length.

To identify when the device is pressed against the thigh, the gesture recognition may include at least one out of two distinct steps:

1. The step of the user holding the device against the thigh at the correct angle without moving the device, and

2. The step of the user moving the device against the thigh for simulating the step of releasing the needle from the tip of the auto-injector by pressing the tip against the thigh.

In the set of instructions, the user is requested to carry out both the gesture 1 and the gesture 2. Simultaneously, the device will search for the corresponding gestures by adequate data processing of data received from the acceleration sensors, gyros or similar sensors of the device.

In particular, the device may calculate a derivative vector from the three acceleration vectors.

Gesture step 1 can be identified by comparing the length of the derivative vector with a limit value to identify whenever the acceleration is below this limit value. When it is identified that the acceleration is below this limit value, the device may start a timer to identify when the acceleration has been below the limit value for a predetermined amount of time. When e.g. the acceleration has been below the limit value for more than one second, two seconds or more, the device may consider that gesture 1 is identified.

Since the movement of the device against the thigh implies firstly an increase in acceleration and subsequently a decrease in acceleration when the device is stopped by the pressure against the thigh, gesture step 2 can be identified by comparing the change in vector length with a limit value for delta vector length, i.e. by finding a change in acceleration being either above or below a predefined value. To improve finding gesture step 2, the device may only consider such change in acceleration provided that the acceleration is in a direction corresponding to the direction from the bottom towards the tip of the auto-injector which is displayed on the screen, i.e. only when the acceleration is in that direction in which the needle is to penetrate the skin. The angle is typically calculated relative to the angle of gravity.

Each one of the gesture steps 1 and 2 could be found independently. However, to improve the precision of the gesture recognition, the device may recognise both gestures 1 and 2 and only consider the needle being injected into the thigh in case gesture step 2 is identified directly after the recognition of gesture step 1.

At this point, the device starts a timer which should verify that the device is held without movement for a period of 10 seconds while the epinephrine is allowed to inject into the muscles. To verify that the device is at least essentially not moved, the device may use signals from any of the acceleration sensors, or the device may compare the length of the derivative vector with a limit value. In case that the limit value is exceeded, the device may inform the user to hold the device longer time against the thigh to allow the epinephrine to enter the body.

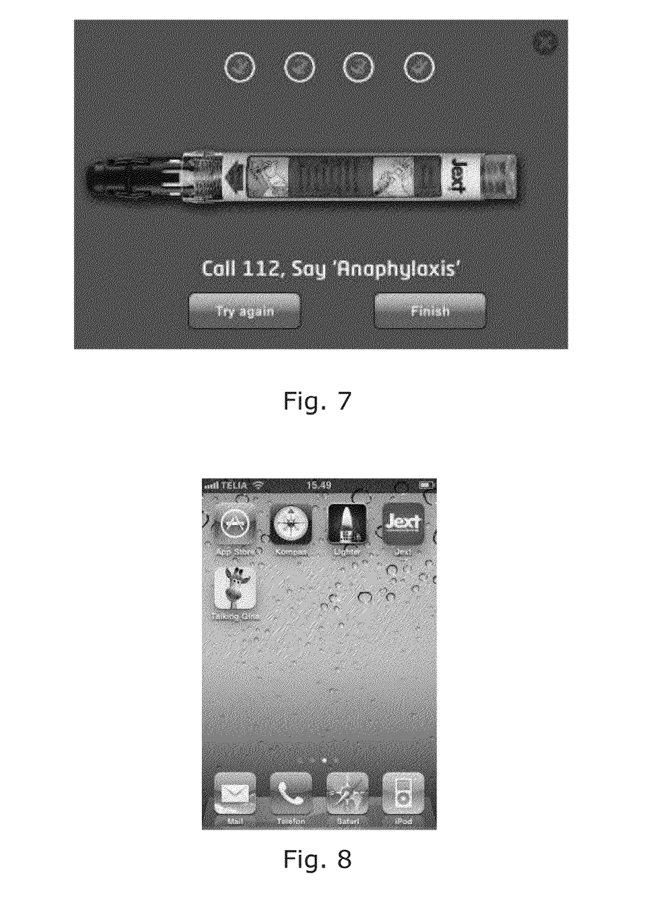

FIG. 7 illustrates a user interaction which could be triggered once the training session has been completed satisfactorily. On this screen, the user is encouraged to dial 112 and say “Anaphylaxis” which is a term which is generally known to medical practitioners and life-saving teams.

FIG. 8 illustrates that the device may be integrated in an I-phone™. In this case, the application-code named “JEXT” causes the Iphone to act as the device according to this invention.

The invention may include to the following particular embodiments:

A handheld computer device for training a user in operating an auto-injector, the device comprising a screen and a sensor which can quantify a physical activity of the device, where the device is adapted, on the screen, to provide a visual representation of the auto-injector, the device further providing instruction for a desired use of the auto-injector, the instructions comprising a request for the user to manipulate the device itself as if it was the auto-injector, the device being further adapted to evaluate data from the sensor and provides a level of compliance with the instructions.

A device wherein the sensor comprises a motion detector movement of the device.

A device wherein the motion detector comprises a 3-axis acceleration sensor capable of providing acceleration in three distinct directions, and an electronic circuit capable of handling data from the sensors to identify a specific physical activity carried out on the device.

A device wherein the sensor comprises a timer for determining duration of a physical state, position or orientation of the device.

A device comprising gesture recognition based on data from the sensor.

A device wherein the instructions relate to an orientation of the auto-injector relative to horizontal.

A device wherein the instructions relate to an orientation of the auto-injector relative to an orientation of the user.

A device comprising an audio output for transmitting an audible signal representing a sound associated with use of the auto-injector.

A device comprising user input means integrated in the screen such that the user is capable of manipulating operation controls on the visual representation of the auto-injector.

A device adapted to carry out the evaluation of data from the sensor while the instructions are provided on the screen.

A device wherein the instructions is for desired use of an epinephrine auto-injector.

A device wherein the screen is a touch screen and the device is adapted to detect movement of fingers over the visual representation to simulate an operation carried out on the represented auto-injector.

A device further adapted to visualise physiological responses to anaphylaxis graphically on the screen.

A device where the device forms part of a mobile telephone device

A device adapted to read an identification insignia obtained on a real auto-injector, and to provide instructions and visual representation of that auto-injector being identified by the insignia.

A device wherein the identification insignia includes information regarding the lifetime of the real auto-injector, the device being adapted to alert the user when the real auto-injector must be replaced with a new one.

And the invention may provide a computer program product readable by a hand held computer device and comprising a set of instructions for the device to provide instructions on a screen of a device for use of the auto-injector, the instructions comprising representing the auto-injector visually on the screen and a request for the user to manipulate the device itself as if it was the auto-injector, the program further comprising instructions for the device to carry out the steps of evaluating sensor data which indicates a physical activity of the device and the step of providing a level of compliance with the instructions.

And the invention may provide a method for training use of an epinephrine auto-injector, the method comprising the steps of providing instructions on a screen of a handheld device for use of the auto-injector, the instructions comprising representing the auto-injector visually on the screen and a request for the user to manipulate the device itself as if it was the auto-injector, the method further comprising the steps of evaluating sensor data which indicates a physical activity of the device and the step of providing a level of compliance with the instructions.

1. A method for training the use of an auto-injector, the method comprising:
providing a handheld computer device, a motion sensor, and an electronic circuit, the handheld computer device having a screen, the motion sensor being configured to generate motion sensor data based on a motion of the handheld computer device, and the electronic circuit being configured to recognise a gesture based on the motion sensor data;
providing instructions on the screen, the instructions being for a desired use of the auto-injector;
representing the auto-injector visually on the screen;
providing, via the handheld computer device, a request for the user to manipulate the handheld computer device as if the handheld device was the auto-injector;
manipulating the handheld computer device such that the motion sensor provides the motion sensor data, the manipulating comprising pressing the device against a bodily surface; and
determining, by the electronic circuit, a level of compliance with the instructions based on the manipulating.

2. The method according to claim 1, further comprising:
informing the user about the level of compliance with the instructions.

3. The method according to claim 1, further comprising:
detecting, by the electronic circuit the manipulating.

4. The method according to claim 3, wherein the detecting is determined from the motion sensor data, the motion sensor data indicating whether a movement of the device in a specific direction is stopped.

5. The method according to claim 1, further comprising:
activating a timer upon recognition of a gesture indicating that the handheld device has been pressed against the bodily surface, the timer being included in the handheld computer device, wherein the determining is based on an output of the timer.

6. The method according to claim 5, wherein the pressing of the handheld computer device against the bodily surface is maintained for a period of time, the counter is configured to count the period of time.

7. The method according to claim 5, further comprising:
holding the handheld computer device in a desired orientation.

8. The method according to claim 7, further comprising:
detecting, by the electronic circuit, the holding.

9. The method according to claim 8, further comprising:
activating the electronic circuit to establish the recognition of the holding prior to the pressing of the handheld computer device against the bodily surface.

10. The method according to claim 8, further comprising:
activating the electronic circuit to establish the recognition of the holding after the pressing of the handheld device against the bodily surface.

11. The method according to claim 5, further comprising:
activating the electronic circuit to establish the recognition of the holding prior to the activation of the timer.

12. The method according to claim 11, wherein the timer is activated throughout the holding.

13. The method according to claim 1, wherein the determining the level of compliance is carried out by comparing the motion sensor data with target reference data, the target reference data expressing desired manipulation of the handheld computer device, the target reference data being preloaded into the handheld computer device.

14. The method according to claim 13, wherein the determining the level of compliance further comprises informing the user of whether the motion sensor data is in accordance with the target reference data.

15. The method according to claim 1, wherein the handheld device includes an elongated, flat box with two substantially parallel main faces, two substantially parallel side portions, and substantially parallel bottom and top end portions, and wherein the manipulating occurs when the user grabs the handheld computer device by pressing a hand at least against the side portions and subsequently moves the handheld computer device until the bottom end portion is pressed against the bodily surface.

16. A handheld computer device for training a user in operating an auto-injector, the device comprising:
a screen;
a motion sensor configured to provide motion sensor data based on a motion of the handheld computer device; and
an electronic circuit configured to,
recognise a gesture based on the motion sensor data,
provide instructions on the screen for a desired use of the auto-injector, the instructions comprising,
a request for the user to manipulate the handheld computer device as if the handheld computer device was the auto-injector, and
a request to press the handheld computer device against a bodily surface, and
determine a level of compliance with e instructions based on the manipulation.

17. The handheld computer device according to claim 16, further comprising:
a memory including preloaded data, the preloaded data expressing at least one desired gesture corresponding to the instructions, the electronic circuit being configured to sample, using said motion sensor, data expressing obtained movement of the handheld computer device while the user moves the handheld computer device, said sampled data comprising at least an angle of the handheld computer device, the electronic circuit being configured to determine a deviation between the sampled data and the preloaded data and to provide an output representing said deviation to the user.

18. The handheld computer device according to claim 16, wherein the motion sensor comprises a three-axis acceleration sensor configured to provide acceleration in three distinct directions.

19. The handheld computer device according to claim 16, further comprising:
a timer configured to activate upon recognition of a gesture indicating that a user has pressed the device against the bodily surface, wherein the electronic circuit is configured to determine a level of compliance with the instructions based on an output of the timer.

20. The handheld computer device according to claim 19, wherein the electronic circuit is configured to recognise a gesture of holding the device in the desired orientation.

21. The handheld computer device according to claim 16, wherein the memory includes a library of predefined instructions, and the electronic circuit is configured to select the instructions from the library of predefined instructions based on an instruction sequence.

22. The handheld computer device according to claim 21, wherein the electronic circuit is configured to control the handheld computer device to express the instructions audibly.

23. The handheld computer device according to claim 21, wherein the instructions are selected from the library based on a recognised gesture.

24. The handheld computer device according to claim 16, wherein the instructions are for the desired use of an epinephrine auto-injector.

25. The handheld computer device according to claim 16, further comprising:
a device configured to read an identification insignia obtainable on a real auto-injector, wherein the electronic circuit is configured to provide instructions and visual representation of the real auto-injector being identified by the insignia.

26. The handheld computer device according to claim 25, wherein the identification insignia includes information regarding the lifetime of the real auto-injector, and the handheld computer device is configured to to alert the user when the real auto-injector should be replaced.

27. A non-transitory computer readable medium comprising computer program product, the computer prop am product being readable by a handheld computer device, the handheld computer device comprising a screen, a motion sensor adapted to provide motion sensor data, and an electronic circuit, the computer program product comprising a set of instructions for the handheld computer device, the instructions enabling the handheld computer device to:
represent an auto-injector visually on the screen;
provide instructions on the screen for a desired use of the auto-injector, the instructions comprising a request for the user to manipulate the handheld computer device itself as if the handheld computer device was the auto-injector; and
evaluate the motion sensor data to recognise a gesture; and
determine a level of compliance with the instructions based on the gesture.

28. (canceled)
